(19) United States
(12) Patent Application Publication
(10) Pub. No.: US 2016/0096145 A1
(43) Pub. Date: Apr. 7, 2016

(54) WASTE WATER CLEANING SYSTEM WITH SELF-CLEANING MICROFILTERS

(71) Applicant: Derek Oxford, Alvin, TX (US)

(72) Inventor: Derek Oxford, Alvin, TX (US)

(21) Appl. No.: 14/540,358

(22) Filed: Nov. 13, 2014

Related U.S. Application Data
(60) Provisional application No. 62/061,028, filed on Oct. 7, 2014.

(51) Int. Cl. B01D 65/02; C02F 1/44

(52) U.S. Cl. CPC B01D 65/02; C02F 1/444; B01D 2321/04

(57) ABSTRACT

Systems for cleaning waste water described herein include an integrated and portable skid having a clarifier and a microfiltration tank. The microfiltration tank includes a plate with a plurality of microfilters, the microfilters each including a sock filter that hangs down into the microfiltration tank from the plate. The system may periodically clean the microfilters by opening a backwash valve below the microfiltration plate, reversing water flow through the microfilters based on a negative pressure drop, separating particulate from the microfilter walls.

### CROSS REFERENCE TO RELATED APPLICATIONS

This patent application claims priority to provisional application No. 62/061,028, which was filed on Oct. 7, 2014 and is incorporated herein by reference.

### DESCRIPTION OF THE INVENTION

1. Field of the Invention

The embodiments relate generally to apparatuses and methods for cleaning waste water, including portable systems for cleaning waste water at small industrial facilities such as breweries.

2. Background of the Invention

Nearly all industrial facilities produce waste water. This water is not reusable without processing that is done either by a water treatment plant or through purchase of expensive water treatment equipment that is economically infeasible for many industrial operations.

For example, many breweries cannot afford water treatment equipment that generally is not suitable for relatively small industrial operations. Instead, these breweries simply expel their waste water, relying on outside water treatment facilities to clean it, and must purchase all new water to keep their processes going.

Current solutions are also inefficient. For example, filtration plates must be removed to replace individual sock filters that screw in from the bottom of a plate. Removing the plate requires stopping the cleaning process.

Additionally, available small-scale cleaning rigs do not typically clean GPM of water to be practical or effective.

Consequently, a need exists for improved apparatuses and methods for apparatuses and methods for cleaning waste water.

### SUMMARY OF THE INVENTION

Embodiments described herein include systems and methods for cleaning waste water. In one embodiment, the system includes a clarifier, a filtration tank, a filter mount plate within the filtration tank, and a base. The filtration tank may have an input and an output. The output may eject reusable water, and may include a pneumatic valve that closes when the backflow valve opens in one embodiment. This may be achieved, for example, based on the water volume that is held in the output that drops below

It is to be understood that both the foregoing general description and the following detailed description are exemplary and explanatory only and are not restrictive of the invention, as claimed.

The accompanying drawings, which are incorporated in and constitute a part of this specification, illustrate one (several) embodiment(s) of the invention and together with the description, serve to explain the principles of the invention.

### BRIEF DESCRIPTION OF THE DRAWINGS

FIG. 1 is an exemplary schematic for cleaning waste water, in accordance with an embodiment.

FIG. 2 is an exemplary schematic for cleaning waste water, in accordance with an embodiment.

FIG. 3 is an exemplary system for cleaning waste water, in accordance with an embodiment.

FIG. 4 is an exemplary system for cleaning waste water, in accordance with an embodiment.

FIG. 5 is an exemplary system for cleaning waste water, in accordance with an embodiment.

FIG. 6 is an exemplary system component for cleaning waste water, in accordance with an embodiment.

FIG. 7 is an exemplary system component for cleaning waste water, in accordance with an embodiment.

FIG. 8 is an exemplary system component for cleaning waste water, in accordance with an embodiment.

FIG. 9 is an exemplary see-through view of a system component for cleaning waste water, in accordance with an embodiment.

FIG. 10 is an exemplary filter mount plate, in accordance with an embodiment.

FIG. 11 is an exemplary filter mount plate, in accordance with an embodiment.

FIG. 12 is an exemplary filter mount plate, in accordance with an embodiment.

FIG. 13A is an exemplary profile view of a microfilter, in accordance with an embodiment;

FIG. 13B is an exemplary profile view of a microfilter, in accordance with an embodiment;

FIG. 13C is an exemplary illustration of a coupling member for a microfilter (i.e., sock filter), in accordance with an embodiment.

FIG. 14 is an exemplary see-through view of a system component for cleaning waste water, in accordance with an embodiment.

FIG. 15 is an exemplary see-through view of a system component for cleaning waste water, in accordance with an embodiment.

FIG. 16 is an exemplary profile view of a filter mount plate for cleaning waste water, in accordance with an embodiment.

### DESCRIPTION OF THE EMBODIMENTS

Reference will now be made in detail to the present embodiment(s) (exemplary embodiments) of the invention, an example(s) of which is (are) illustrated in the accompanying drawings. Wherever possible, the same reference numbers will be used throughout the drawings to refer to the same or like parts. All dimensions and measurements provided in the figures are exemplary and non-limiting.

In one embodiment, the system may include an integrated rig that cleans waste water at an industrial facility for reuse. The system may receive waste water from a waste output at the industrial facility, such as a brewery, and then processes the waste water through a preliminary stage, such as through a static mixer and clarifier, then passes the clarified solution through a microfiltration process. In an embodiment, the microfiltration tank may include a plurality of microfilters that may be individually removed (e.g., for cleaning) from a microfiltration plate within the tank without removing or otherwise disturbing the microfiltration plate. Each microfilter may also be stopped in one embodiment by screwing a stopper into the microfilter and without having to remove it from the microfiltration tank.

Clarified solution may be drawn through the microfilters in one embodiment, causing waste “blowdown” to fall to the bottom of the microfiltration tank. The water that is drawn through the microfilters is discharged as cleaned (i.e., reusable) water in one embodiment, such that the clean water discharged may be attached to a system water input.

Waste may periodically empty from both the clarifier and the microfiltration tank into a waste tank, and from there the waste may be further filtered or pressed such that non-solid solution is returned to the mixing and clarification processes.

In one embodiment, a backwash valve below the microfiltration plate may periodically open to cause the water above the backwash plate to pass back through the microfilters, dislodging particles that may accumulate on the microfilters. This temporary flow reversal may cause the microfilters to flex, dislodging particles from the outer surface, which in turn may drain into the backwash valve or fall to the bottom of the tank.

In one embodiment, the backwash valve may automatically open when a pressure drop of approximately 5 PSI develops. This pressure drop may be created based on the length of a clean discharge run above the microfiltration plate in one embodiment.

In one embodiment, unlike prior art techniques, a system herein may generate consistent particles in the 50μ+/−10μ (3σrange) while maintaining exceptionally high flow rates through the membranes. The measurement for flow through a membrane system is gallons per square foot of membrane per day (GFD). Whereas a typical microfilter GFD is between 50 to 150 GFD, in an embodiment herein a system may achieve about 750 to 1,200 or more GFD. This dramatic GFD increase may allow for a smaller footprint with increased system performance, all while keeping down the capital cost of the system, allowing the system to be purchased by smaller industrial facilities and clients.

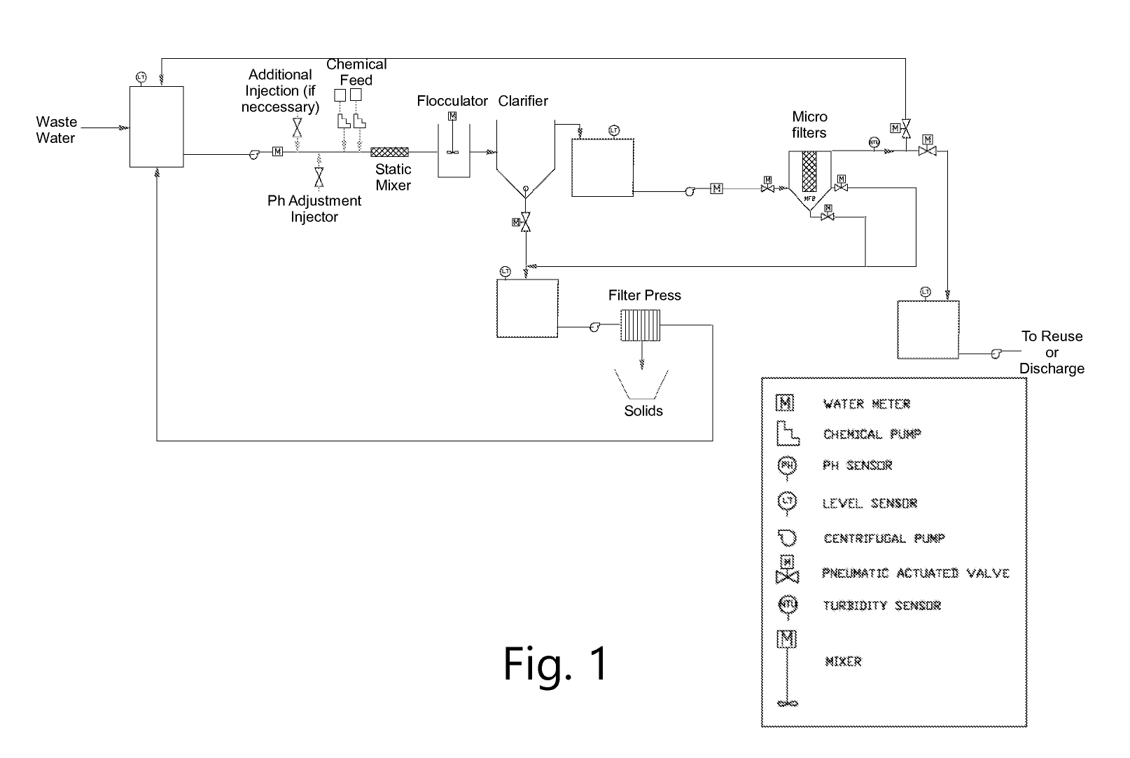

FIG. 1 includes an exemplary schematic of system components used in a water cleaning process, in accordance with an embodiment. The components may be assembled together on a single transportable skid in one embodiment, such as a trailer or shipping container.

As shown in FIG. 1, waste water from an industrial facility may flow into a waste input tank (T1). The waste solution may flow from the waste input tank through a pre-cleaning process that may include injection of chemicals (e.g., aluminum chlorohydrate), pH adjustment (e.g., via injection), and/or mixing.

The mixing may be accomplished in one embodiment via a static mixer. The static mixer may include an elongate tube having ribbons for to stimulate turbulent flow.

In the example of FIG. 1, the mixing occurs prior to the solution passing to the clarifier, but in another embodiment, the mixing may occur after the solution passes out of the clarifier.

The waste solution may pass into a clarifier tank. The clarifier tank may include steep walls at the bottom and/or a weir for collecting waste. In another embodiment, the system may include a flocculator, which may generate “floc” or “flake” by bringing colloids out of suspension in the mixed solution. Essentially, the floculator may cause particles to cluster into sediment such that they are more easily removed from the waste solution.

Clarified solution may then pass into one or more microfiltration tanks, where a microfiltration process is applied. The microfiltration tank(s) may include several inputs and outputs in one embodiment. For example, working from top to bottom, the microfiltration tank may include a product output (i.e., for clean reusable water). Below that, a filter plate may be welded or otherwise attached to the inside of the microfiltration tank. Below that, a backwash output may be present that recycles non-filtered solution back to the clarifier or, alternatively, to the pre-cleaning or a waste tank, where it may eventually make its way back to the clarifier. Below the backwash output, a feed input my supply clarified solution from the clarifier to the microfiltration tank. Then towards the bottom of the microfiltration tank, a blowdown output for solids may allow for the solid wastes to be output for further processing, such as at T4 and/or through a filter press.

Continuing with FIG. 1, the cleaned solution output from the microfilter tank may be collected in an additional tank for reuse in the industrial system, or for discharge.

In general, liquid solution that does not pass through the microfilters may be recycled back into either the clarifier or an earlier pre-cleaning stage, whereas the solids that are separated as part of the process may be extracted and properly disposed of as waste, or in some cases put into a secondary use, such as fertilizer.

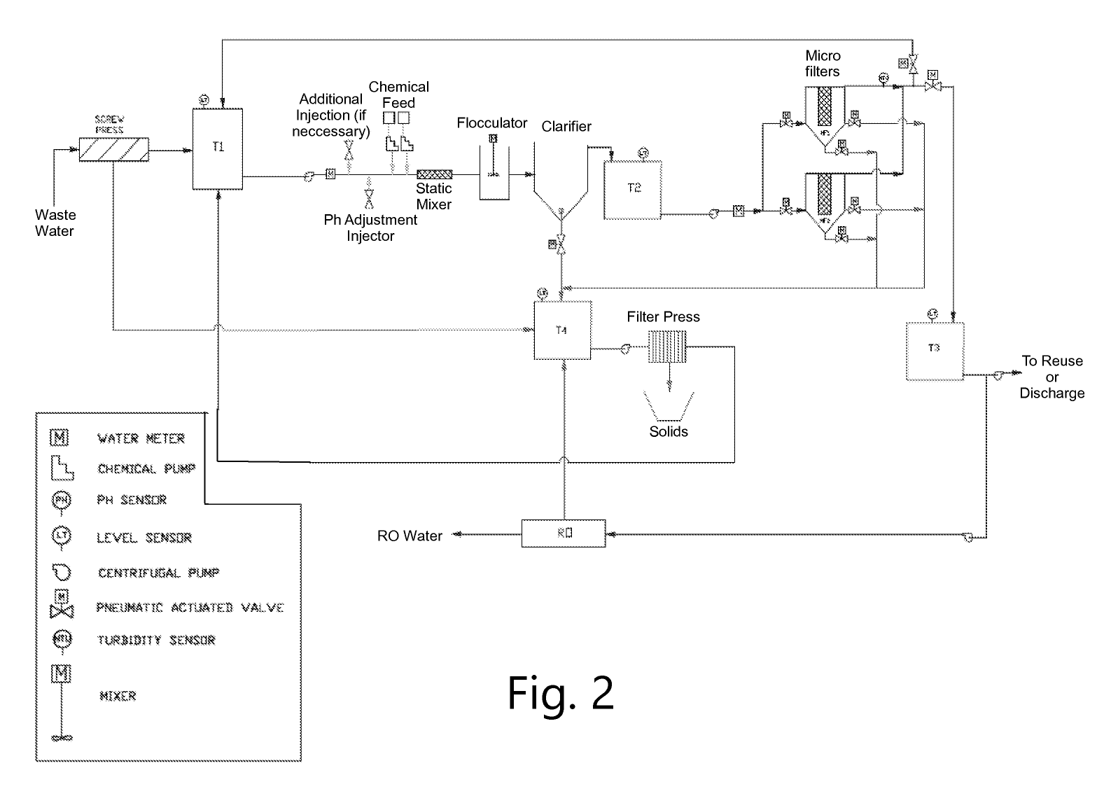

An alternate exemplary schematic is show in FIG. 2. The system of FIG. 2 includes two microfiltration tanks instead of one. In addition, it includes a screw press that the waste water passes through before entering the waste input tank T1.

In one embodiment, a system in accordance with FIG. 1 or 2 may process waste water at a rate of 300 GPM, all on a single transportable skid.

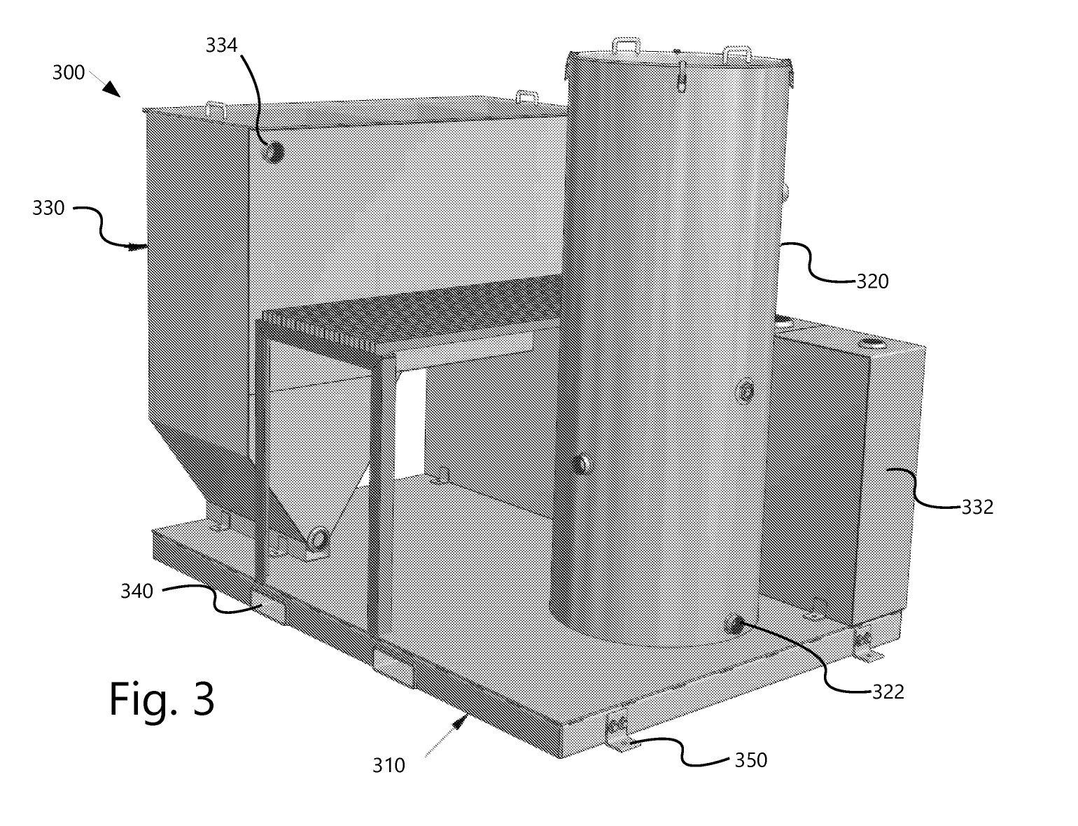

For example, turning to FIG. 3, an exemplary skid 300 may include a base element 310 that holds all the components of the system, including a microfiltration tank 320 and a clarifier tank 330. The clarifier tank 330 may include a clarifier, a fountain, and chambers for backwash and blowdown.

The skid 300 may also include the control station, which may include a processor and touch screen for monitoring and controlling the system performance. The control station may control the various valves, including operating the backflow valve to effectuate cleaning of the microfilters, causing particulate to fall as blowback.

All the necessary tanks and components for operation may be built into the skid 300 in one embodiment. Not only may the skid 300 include a microfiltration tank 320 and a clarifier, but the tanks that feed both may also be built in. For example, the clarifier tank may include holding tank 580 that feeds the clarifier rather than an external tank. Similarly, the blowdown and backwash tank 332 connected to the microfiltration tank may be included on the skid 300. Thus, the entire skid may need only an input for waste water and an output for clean water.

In one embodiment, the skid may be provided in a small shipping container. In another embodiment, the entire skid containing all the parts and components detailed herein is smaller than a shipping container. For example, in an example consistent with the example figures herein, then entire skid 300 may be only about 6 feet deep, 7 feet wide, and less than 6 feet tall. This may allow for placing the skid in a small footprint that many small breweries and other small industrial facilities can afford to use for water cleaning.

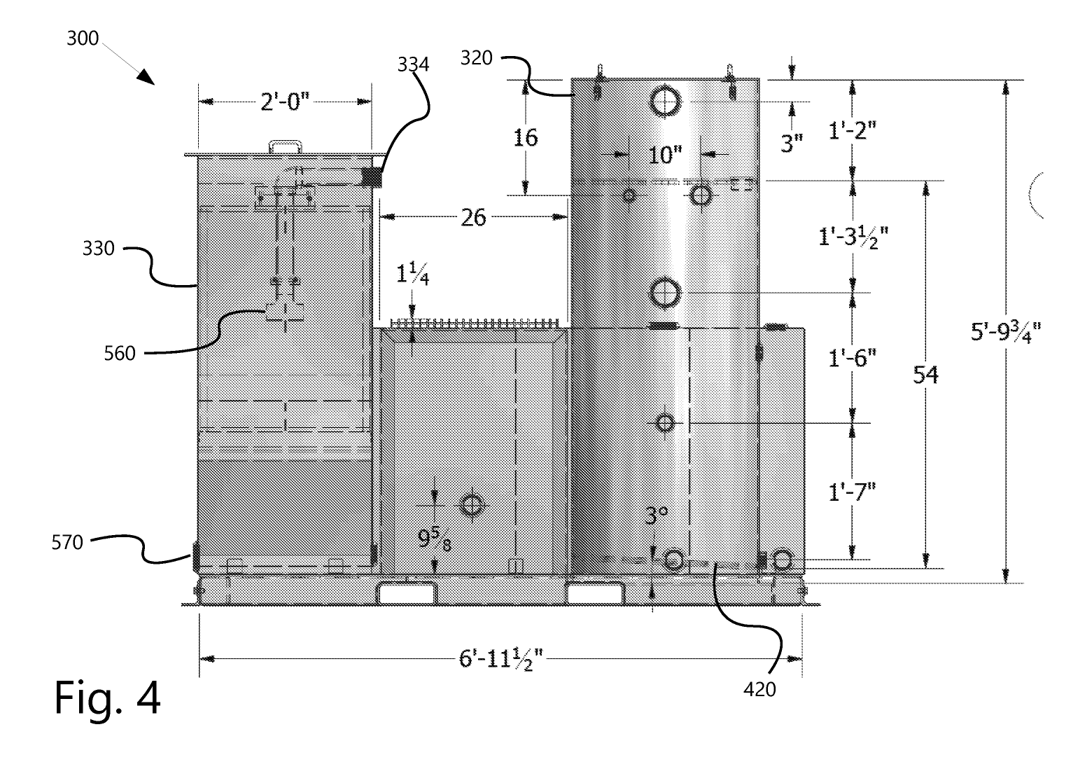

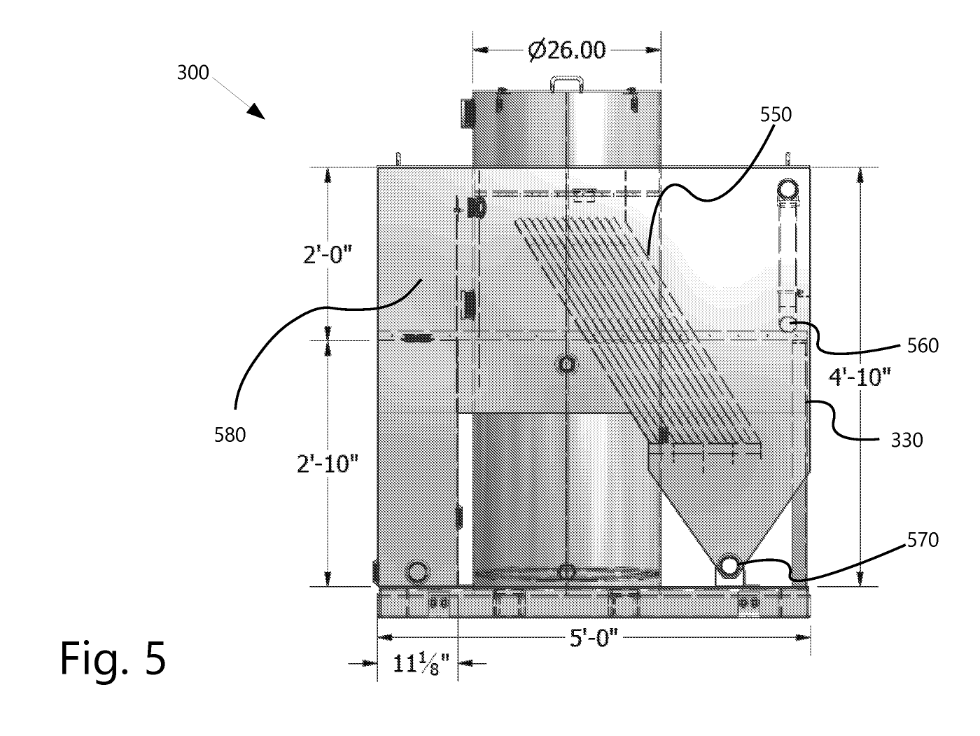

Example non-limiting component dimensions that allow the components to fit on a small skid are shown in FIGS. 4, 5, and 14-16. Additional views of skid 300 are included in FIGS. 4 and 5, with exemplary dimensions noted for each of the system components. These dimensions are for one exemplary embodiment only, and other dimensions are possible in other embodiments.

Continuing with FIG. 3, the base element 310 may include inlets 340 for fork lift teeth, allowing for easier transport in one embodiment. The base element 310 may also be equipped with plates that allow the base element 310 to be bolted to the ground or to a moveable object, such as a trailer.

In one embodiment, the skid 300 is portable. For example, it may be mounted on a trailer and/or towed to a particular location for use.

In another embodiment, the skid 300 is made primarily of stainless steel.

The clarifier tank may accept input of waste solution at input 334 in one embodiment. A mixer may be included in clarifier tank 330 in one embodiment, or may be separately provided before the solution passes into the clarifier tank 330, depending on the embodiment. Tank 332 may include backwash and blowdown compartments in one embodiment.

In one embodiment, the clarifier tank 330 is a round tank instead of the rectangular shape shown in FIG. 3. The clarifier tank may include slopes at the bottom such that the flock collects at an exit point. Chemicals such as aluminum chlorohydrate may be added to make flock, which precipitates and falls out.

A weir structure may be in place at the bottom of the clarifier tank 330 in one embodiment. In one aspect, the weir includes a wall that is at a 48 degree angle, allowing clear solution to flow over the wall while retaining flock. FIG. 5 illustrates one such example, in which a weir wall 550 extends higher than the exit point 560 of the input into the clarifier tank 330. The waste particulate may collect at the bottom of the weir and be expelled through output 570 in one embodiment.

The clarifier may utilize aluminum chlorohydrate in one embodiment to react with the waste solution entering the weir, in order to create flock. The flock may collect in the weir while the clarified water spills over the top of the weir and continues into the microfiltration portion of the system.

In one embodiment, a hopper is used to hold particulate matter that is expelled from the clarifier. In another embodiment, particulate matter also enters the hopper from other portions of the system, such as the filtration tank.

The clarified solution may then pass from the clarifier tank 330 to the filtration tank 320, where the microfiltration process takes place. The weir may feed the microfiltration tank via a feed line in one embodiment, passing the clarified solution into the microfiltration tank at a point below a filtration plate.

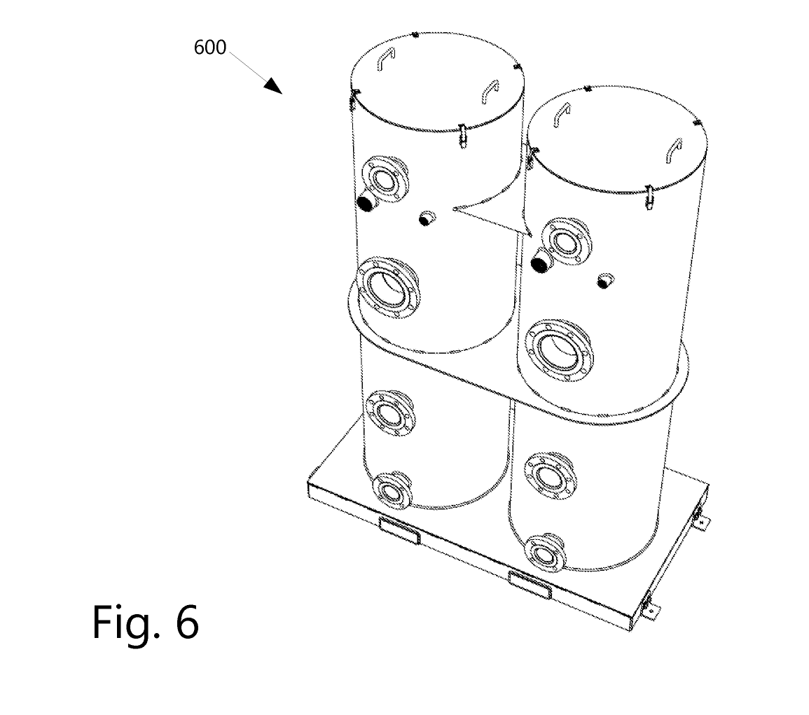

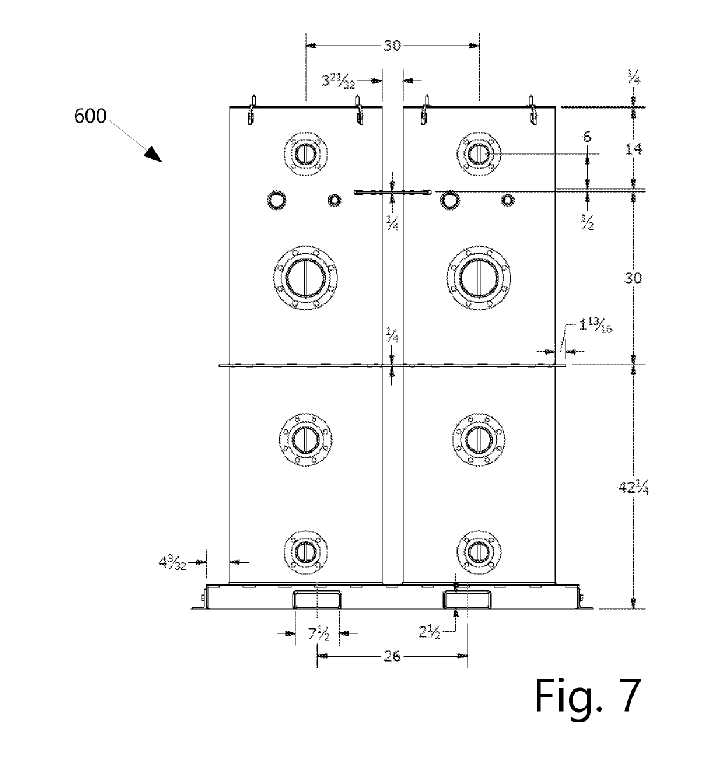

In one embodiment, multiple microfiltration tanks may be utilized. One such exemplary illustration of dual microfiltration tanks 600 is shown in FIG. 6. FIG. 7 provides an alternate view, and includes example non-limiting dimensions.

In order to fit all the system components in a shipping container, in one embodiment multiple microfiltration tanks are used so that each individual tank may be kept short enough to enable removal of the microfilters without requiring a hole to be cut into the top of the microfiltration tank. Thus, the microfilters may also be at most as long as the clearance room above the microfiltration tank. In one such embodiment, a hoist may be slidably mounted along the top of the inside of the container such that it may assist in lifting out the microfiltration plate from the microfiltration tank.

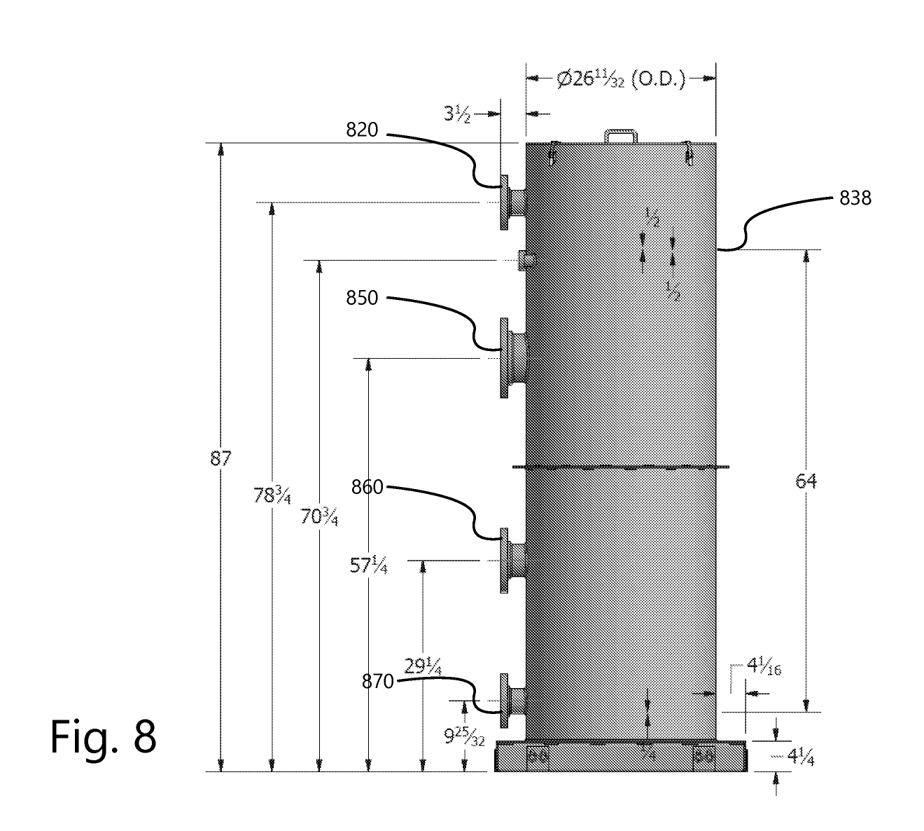

FIG. 8 presents an example microfiltration tank 820, with a view of the most important inputs and outputs as well as exemplary dimensions. The microfiltration process may include passing the waste water through a membrane of microfilters in the filtration tank. The membrane may separate the contaminant particles for the water particles. Thus, solution that passes above the microfiltration plate may generally be considered clean product H₂O, and may exit via a filtered H₂O valve 820. Solution below the microfiltration plate may still need cleaning.

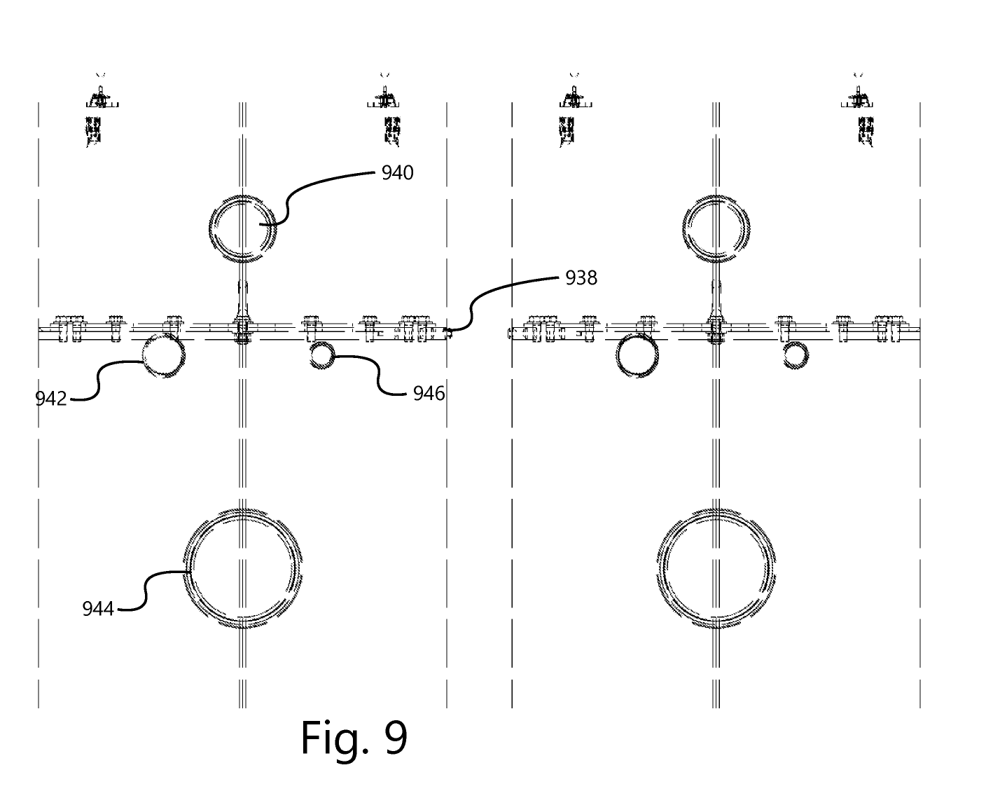

The microfiltration plate may be located at point 838 in one embodiment. An example blown-up cross-section illustration is included in FIG. 9, showing the relative location of the microfiltration plate 938. FIG. 9 shows a dual microfiltration tank configuration, but a single tank embodiment may include just one of the two illustrated tanks.

As is shown in FIG. 9, clean water output 940 is located above the microfiltration plate 938. Pressure above the microfiltration plate 938 may be atmospheric, for example, if the top of the microfiltration tank is open.

Below the microfiltration plate and outside of the microfilters is backwash valve 944. The backwash valve 444 may be a relatively large valve to offer minimal resistance once it is opened.

Also below the microfiltration plate 938 is an air inlet 942 and a pressure sensor inlet at 946. The pressure sensor 946 may be equipped with a reporting pressure sensor that continuously reads the pressure level below the microfiltration tank 938. When a time threshold, pressure threshold, and/or pressure change threshold is met, the system CPU (e.g., processor) may cause the backflow valve 944 to open by pneumatically controlling the valve in one embodiment. To allow the clean water to quickly backflow through the microfilters, the air inlet 942 allows air in below the microfiltration plate to prevent, for example, vapor lock. Without the air inlet 946, the air may be required to pass through the microfilters, which may occur very slowly and greatly reduce the backflow rate.

Continuing with FIG. 8, a pressure-activated backwash valve 850 may be located below the microfiltration plate but above the feed line 860. The backwash valve may recycle backwash solution back into the clarifier for an additional attempt at cleaning if the solution does not pass through the microfiltration membrane after a period of time.

At the bottom, a waste output valve 870 may allow the microfiltration tank 820 to expel solids (e.g., blowdown) that have settled at the bottom. The waste output valve 870 may be pressure actuated such that it opens

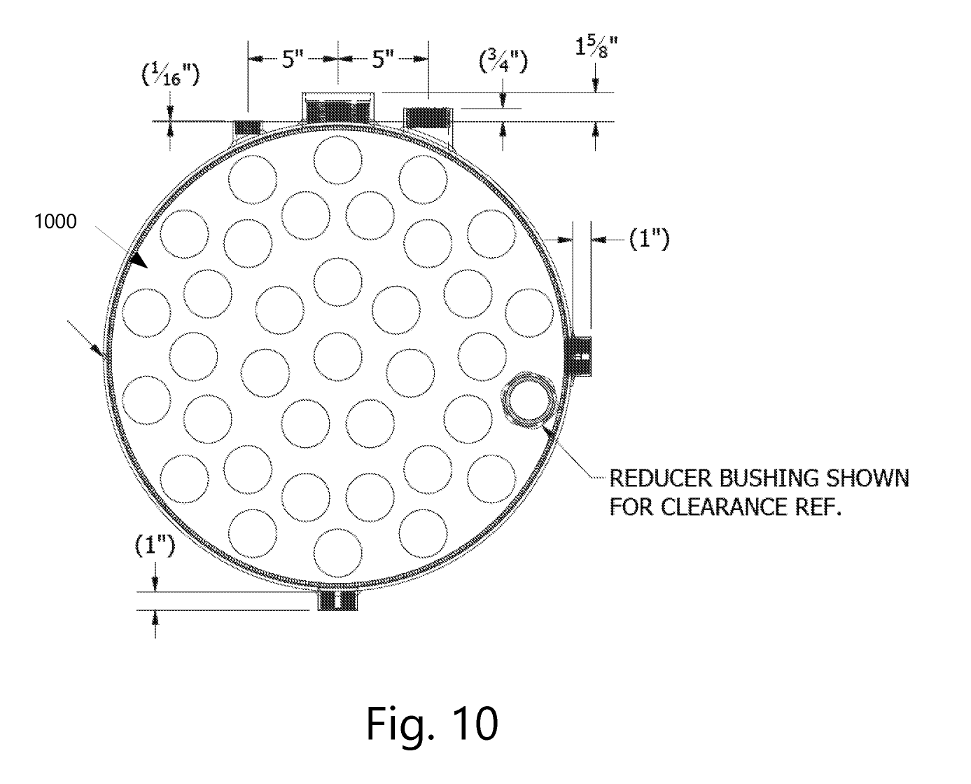

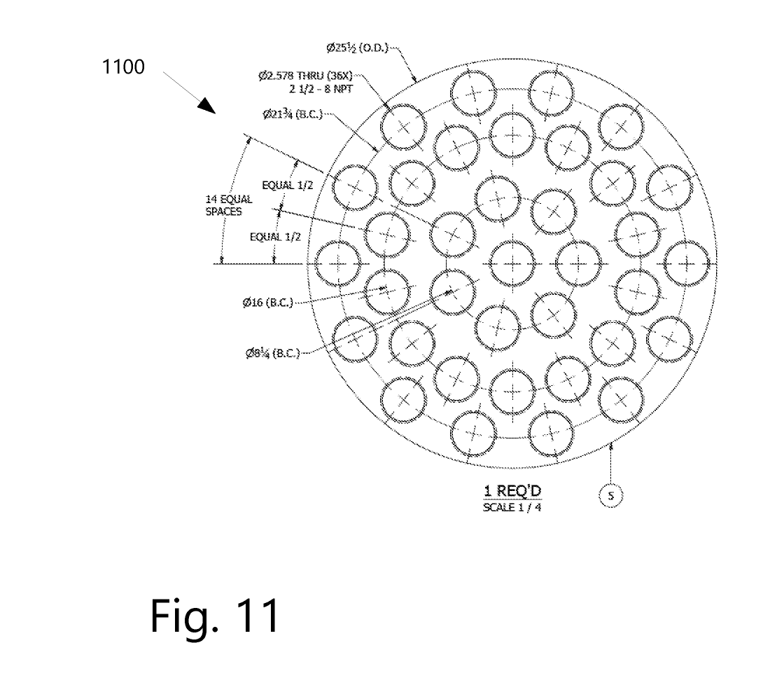

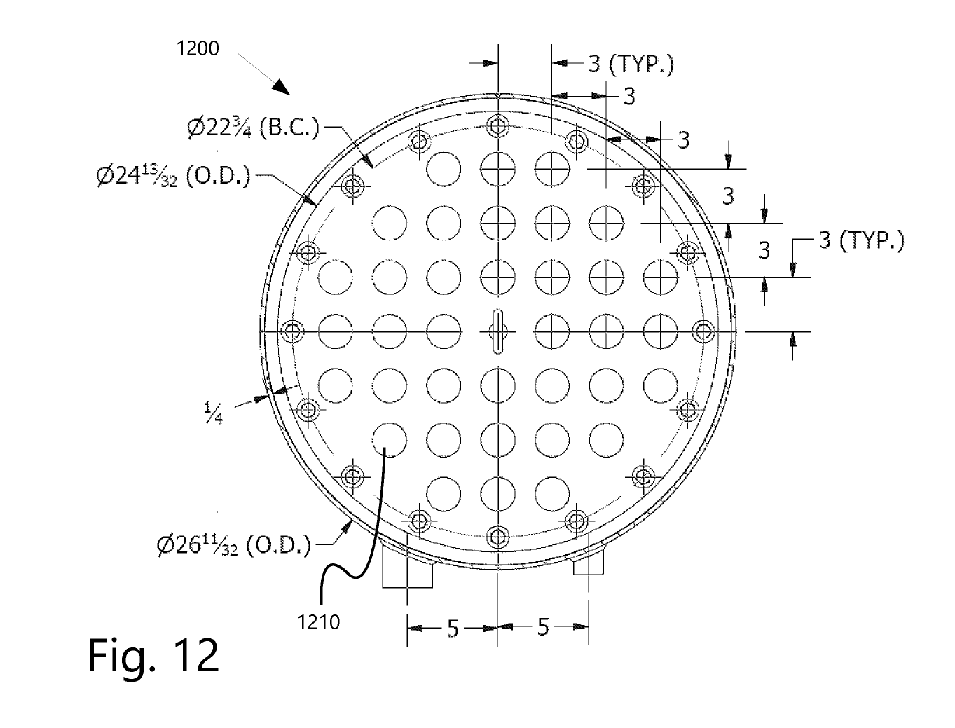

As has been mentioned, in one embodiment, microfiltration particle separation is accomplished by positioning a filter mount plate in the microfiltration tank 320. An exemplary microfiltration plate 1000 is shown in FIG. 10. As shown in FIGS. 11 and 12, the location of the microfilters on the microfiltration plate may vary in different embodiments. For example, they may be ordered in rings, such as in FIG. 11, or ordered in rows, such as in FIG. 12. The portion of the filter plate containing the holes 1210 for filter attachment may be called a “well screen.”

The filter mount plate 1100 or 1200 may include a plurality of holes 1210, for example, as illustrated in FIGS. 11 and 12. These holes may allow for sock filters (i.e., a microfilters) to be installed from the top of the plate 1100 or 1200. The sock filters may allow water particles pass through, while the larger and heavier contaminant particles are filtered and fall to the bottom of the filtration tank. The bottom of the microfiltration tank 320 may include a ramp 420, such as the example in FIG. 4, that helps direct the contaminant particles toward a waste output 322.

Unlike the prior art, microfiltration configurations presented herein may allow for top-down installation and removal of individual microfilters without stopping the microfiltration process. Providing for individual installation and removal of microfilters from the top of the play may have several advantages. Previously, the entire filter plate may need to be removed to change a single bad microfilter, also requiring stopping the water cleaning operation. Embodiments herein allow for individually disabling problem microfilters, and then individually replacing them without stopping the water cleaning process and without removing or otherwise altering the position of the microfiltration plate (i.e., well screen).

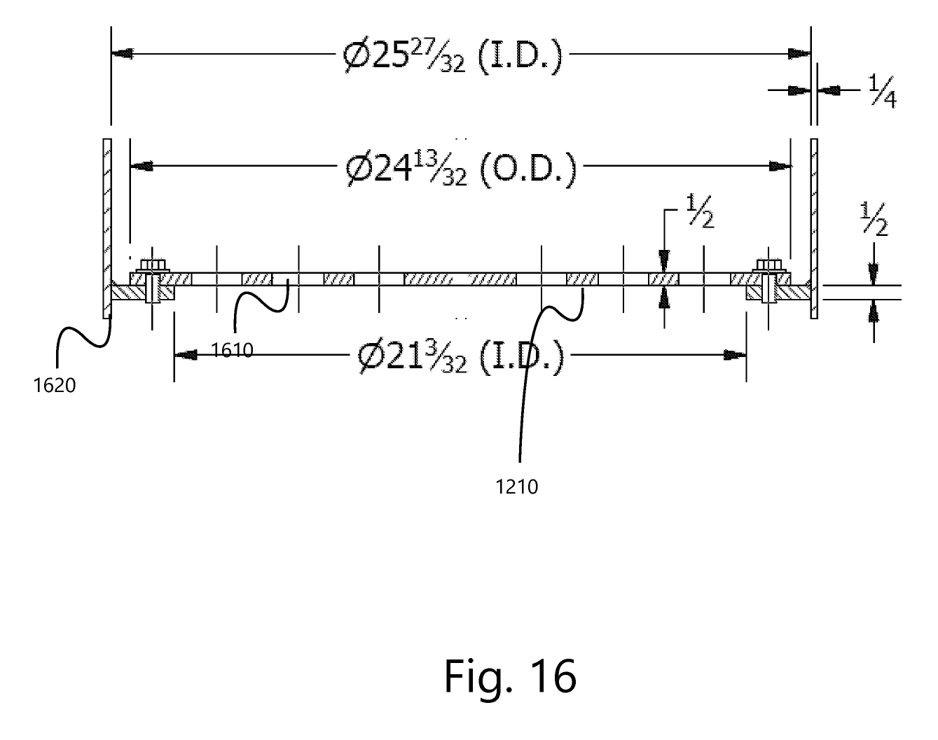

Thus, embodiments herein also allow for the microfiltration plate to be permanently welded in place within the microfiltration tank rather than installed as removable plate in one embodiment. Permanently welding the plate in place may allow for creating a more exact pressure drop from the top of the plate to the bottom, and may also be less expensive than the extra precision and engineering required for implementing a removable plate. An example cross-sectional view of a filter plate 1610 that is installed within a microfiltration tank 1620 is shown in FIG. 16.

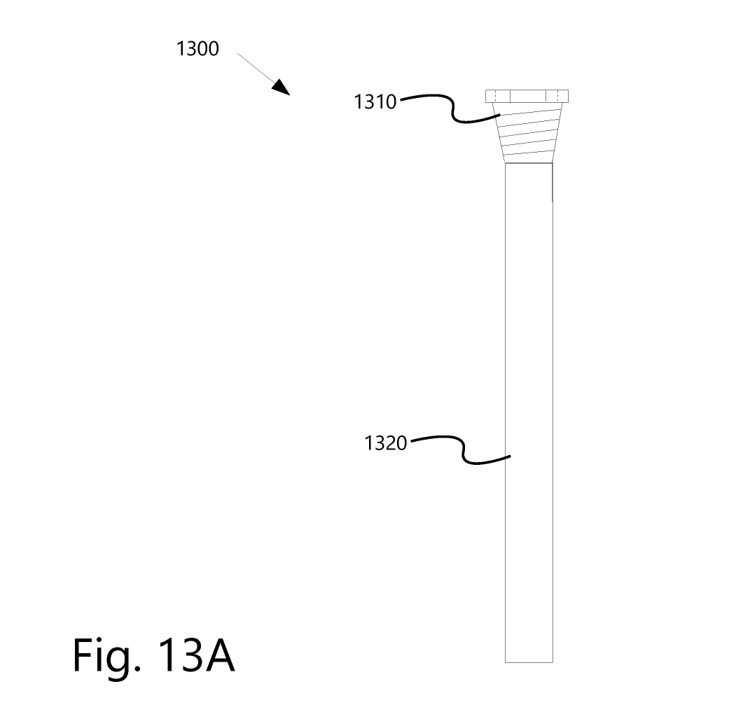

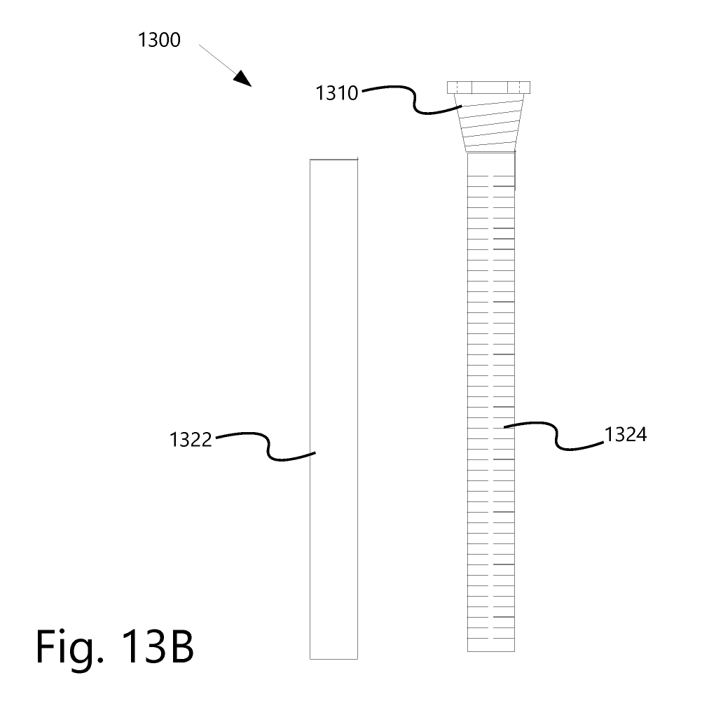

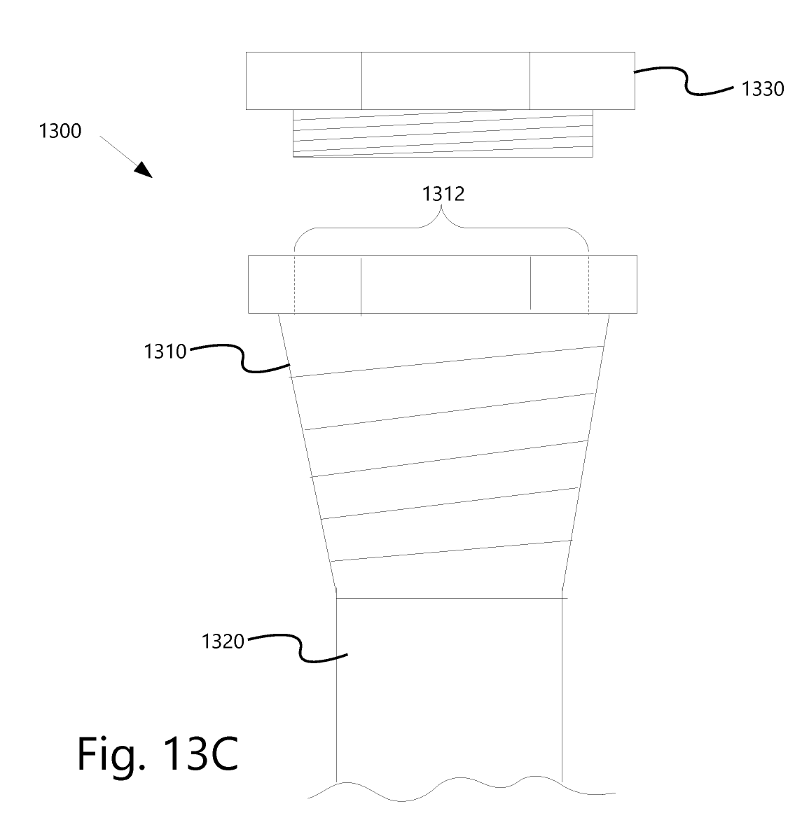

Turning to FIG. 13A, an exemplary microfilter 1300 (i.e., sock filter) is presented. As is shown in FIG. 13A, the sock filter 1300 may include both an attaching member 1310 and an elongate sock filter passage 1320. The elongate filter passage 1320 may allow for increased filter surface area, allowing more water to be filtered in a smaller space. Once all of the microfilters are installed in the plate, the filter passages hang down from the plate and into the portion of the microfiltration tank were the clarified solution exists (i.e., the solution that still contains particulate that needs cleaning).

As shown in FIG. 13B, the elongate filter passage 1320 may include both a Teflon sock 1322 and a rigid support member 1324. The rigid support member 1324 may include slits that allow liquid to pass through while still retaining rigidity to support the correct shape of the Teflon sock 1322. The Teflon sock 1322 may slide over the rigid member 1324, covering the bottom and cylindrical wall of the rigid support member 1324.

The diameter of the elongate filter 1320 may be slightly less than the diameter of the holes in the well screen, allowing the microfilter 1300 to be installed and/or removed individually from the top of the well screen by sliding the elongate filter 1320 down through the hole until the attaching member 1310 can be screwed into the hole.

Additionally, the attaching member 1310 may be tapered and act as a gasket when installed (e.g., screwed downward) into a hole in the well screen (i.e., microfilter plate). In one embodiment, this is accomplished by threading the attaching member 1301 in compliance with national pipe thread standards such that no gasket is needed. Each hole in the well screen may also be threaded to accept the attaching member

The inside of the attaching member 1310 may be bored out such that the thickness is around schedule 80 thickness in one embodiment.

As shown in FIG. 13C, the microfilter 1300 may also include a stopper 1330 that may be screwed down into the interior passage 1312 (i.e., inside diameter) of the attaching member 1310. This may allow for shutting off an individual microfilter 1300 that has gone bad by blocking the passage through which water would otherwise pass. Although the threading is shown as non-tapered in this example, it may alternatively be tapered in another embodiment.

In operation, clarified solution enters the clarifier tank below the microfiltration plate, and filling the tank may cause water particles to flow up through the microfilters (i.e., membranes) to the top of the microfiltration plate.

Cleaning the microfilters mounted in the microfiltration plate may be accomplished with a temporary flow reversal achieved when a backwash valve opens below the microfiltration plate to create a pressure drop. The pressure drop may be created based on the surface area of the membranes and by lengthening the valve run for the backwash. In one embodiment, clean water passes back through the microfilters and the backwash exits through the backwash valve, which may be 9 to 9.5 feet long. This valve length in conjunction with exemplary dimensions of the microfiltration tank may cause the aforementioned pressure drop. If the dimensions of the microfiltration tank are different than the exemplary embodiment, then the length of the clean exit valve may also be changed accordingly to provide the same pressure drop. In general, 26 gallons of water may create the 5 PSI drop. In another embodiment, the backwash valve is between 6 and 10 feet long.

For example, a pressure difference from 12 PSI to 7 PSI may be created by opening a backwash valve, at which point the pressure immediately drops from 12 to 7 PSI. At that time, the pressure above the membrane (clean water) is greater than the pressure outside the membrane within the tank. This causes the clean water to wash back through the microfilters, flexing the microfilters, and causing the backwash to flow through the backwash valve until the pressure difference subsides or the backwash valve is closed.

In more detail, by dropping the pressure by 5 PSI from below the filter plate to the top of the clean water above the filter plate, the material of the membrane (i.e., filter passages 1320) may flex. The water pressure may push the material open, allowing water to flow until the negative pressure recedes. In one embodiment, when the material flexes, 0.2 to 0.5 GPM of reverse flow moves through the membranes, dislodging particulate that may have collected on the membrane.

In one embodiment, the backwash value is pneumatically actuated. For example, when enough pressure has accumulated such that a negative 5 PSI drop can be achieved by opening the backwash valve, the valve may be automatically opened. This may occur periodically, such as every 20 minutes. For a backwash valve having a 9.5 foot length, opening the backwash valve may also cause the membranes of the micro filters to flex and remain open for roughly one minute and thirty seconds, causing clean water to move through the valve.

In one embodiment, the backwash valve is opened when a pressure threshold in the tank is reached. For example, if the pressure reaches 15 PSI in one embodiment, the backwash valve opens. In another embodiment, the backwash valve opens when the system detects a pressure increase that exceeds a predetermined rate, which may allow the system to prevent high pressure levels. In still another embodiment, if a time threshold since the backwash valve last opened is met, the backwash valve is opened. In one embodiment the time threshold is 20 minutes.

Atmospheric pressure above the microfiltration plate may also be taken into account when setting a pressure threshold to open the backwash valve and create the pressure drop. In general, the atmospheric pressure at that location will be within 8 to 12 PSI. Within that range, roughly 26 gallons of water volume between the microfiltration plate and valve will create the necessary pressure drop. The longer surface area of a longer backwash valve run (e.g., 9 to 9.5 feet) will assist in creating the pressure drop based on this water volume.

As has been discussed, blowdown may fall to the bottom of the tank. Once sufficient solids have gathered at the bottom, it may be ejected. Non-performing effluent may be recycled in one embodiment. Non-performing effluent may be recycled back to the front of the system for retreatment in one embodiment.

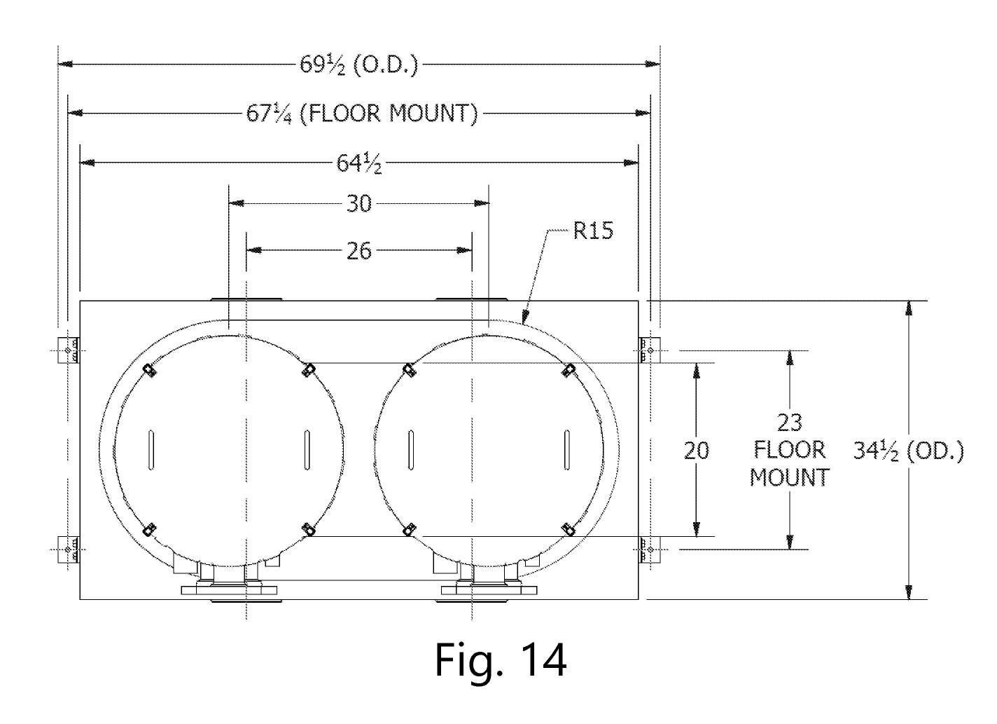

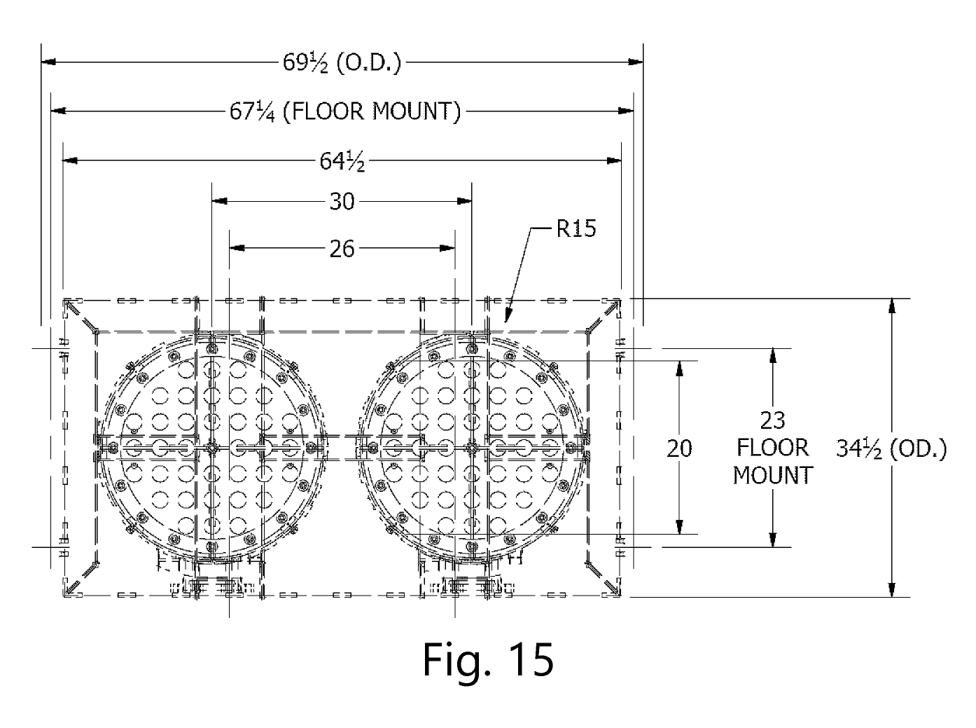

Exemplary dimensions for dual microfiltration plates and tanks are provided in FIGS. 14 and 15.

Any portion of this technology may be computerized. The analytical portion of this system may be extensive and as such may be readily loaded onto disc for regulatory compliance reporting as well as day to day monitoring of the performance. Potential system attributes that may be monitored by a processor may include: pH, flow, auto-BOD, auto CNP (i.e., carbon, nitrogen and phosphorous) and auto-ATP (i.e., adenosine triphosphate, the determining factor found in all living organisms) and NTU (i.e., normal turbidimetric values), and pressure in various spots of the system to make sure the system is operating as intended.

Therefore, the system may have total oxidizable carbon values, total nitrogen values, total phosphorous values, BOD several times a day, and traceable values to determine the presence or absence of living organisms, e.g. virus, bacteria, spores, etc. in the final effluent.

Additionally, the pressure drop may be assisted by computerized pressure regulation in one embodiment. For example, the pressure within the microfiltration tank above the plate may be regulated to assist the 5 PSI pressure drop on a schedule of every 20 minutes. Pressure sensors both above and below the plate may be used to monitor the pressure at each location.

Other embodiments of the invention will be apparent to those skilled in the art from consideration of the specification and practice of the invention disclosed herein. It is intended that the specification and examples be considered as exemplary only, with a true scope and spirit of the invention being indicated by the following claims.

What is claimed is:

1. A system for cleaning waste water, the system including:
a base;
a clarifier tank positioned on the base;
a microfiltration tank positioned on the base, the microfiltration tank including a microfiltration plate that includes a plurality of microfilters, wherein the microfiltration tank includes a plurality of valves including:
a clean water output above the plate in the microfiltration tank;
an input below the plate that receives a solution for cleaning from the clarifier or a mixer into the microfiltration tank; and
a backwash valve that automatically opens to create a pressure drop of at least 4 PSI between the output and the backwash valve, causing clean water to flow back through the microfilters.

2. The system of claim 1, wherein the microfiltration plate is welded to the microfiltration tank and the plurality of microfilters are each individually removeable and include an attachment member and a sock filter, the sock filter hanging below the plate when the microfilter is mounted on the plate.

3. The system of claim 2, wherein the attachment members are threaded and tapered such that they form a gasket when screwed into the plate from the top of the plate.

4. The system of claim 3, wherein a first of the attachment members is individually replaceable and includes threading along an interior passage of the first attachment member for individually capping the first attachment member.

5. The system of claim 1, wherein the backwash valve opens to create a negative pressure of about negative 5 PSI, and wherein the negative pressure causes liquid to pass back through the plurality of microfilters to the backwash valve.

6. The system of claim 1, wherein the backwash valve is between 6 and 10 feet long.

7. The system of claim 6, wherein the backwash valve is between 9 and 9.5 feet long.

8. The system of claim 1, wherein opening the backwash valve causes a reverse flow of between 0.2 and 0.5 GPM through the membranes.

9. The system of claim 1, wherein the base is coupled to a portable rolling structure.

10. A compact water cleaning skid including:
a base having dimensions of less than 7 feet wide and 7 feet deep, wherein at least the following components are affixed to the base:
a clarifier tank that includes both a solution holding tank and a clarifier with a weir;
a backwash holding tank;
a control center; and
a microfiltration tank including a microfiltration plate having a plurality of sock microfilters, the microfiltration tank including a clean water output above the microfiltration plate and a backwash valve below the microfiltration plate, wherein the backwash valve is actuated by the control center to create a pressure drop and cause cleaned water to flow back through the plurality of sock microfilters.

11. The compact water cleaning skid of claim 10, wherein the backwash valve opens to create a negative pressure of about negative 5 PSI, and wherein the negative pressure causes liquid to pass back through the plurality of microfilters to the backwash valve.

12. The compact water cleaning skid of claim 10, wherein the backwash valve is between 6 and 10 feet long.

13. The compact water cleaning skid of claim 10, wherein about 26 gallons of water volume between the microfiltration plate and backwash valve will create the pressure drop.

14. The compact water cleaning skid of claim 10, wherein opening the backwash valve causes a reverse flow of between 0.2 and 0.5 GPM through the membranes.

15. The compact water cleaning skid of claim 10, wherein opening the backwash valve causes the plurality of sock microfilters to flex due to the back flow.

16. The compact water cleaning skid of claim 10, wherein the base is coupled to a portable rolling structure.

17. The compact water cleaning skid of claim 10, wherein the microfiltration plate is welded to the microfiltration tank.

18. The compact water cleaning skid of claim 10, wherein the plurality of sock microfilters each include:
an elongate sock filter passage that fits down through a threaded hole in the microfiltration tank; and
an attachment member that is tapered and threaded such that it may be screwed down into the threaded hole, thereby forming a gasket.

19. The compact water cleaning skid of claim 18, wherein each attachment member includes threading along an interior passage for individually capping the first attachment member.

20. A water cleaning skid including:
a microfiltration plate;
a clean solution ouput above the microfiltration plate;
a dirty solution input below the microfiltration plate;
a backwash valve below the microfiltration plate; and
actuation circuitry that causes the backwash valve to open, creating a pressure drop that causes clean solution to backflow through the microfiltration plate.
